(19) United States
(12) Patent Application Publication
(10) Pub. No.: US 2007/0003110 A1
(43) Pub. Date: Jan. 4, 2007

(54) System and method for adaptively setting biometric measurement thresholds

(76) Inventors: Srinivas Gutta, Veldhoven (NL); Miroslav Trajkovic, Coram, NY (US); Vasanth Philomin, Stolberg (DE)

Correspondence Address: PHILIPS INTELLECTUAL PROPERTY & STANDARDS, P.O. BOX 3001, BRIARCLIFF MANOR, NY, 10510, US

(21) Appl. No.: 10/574,138

(22) PCT Filed: Sep. 28, 2004
(86) PCT No.: PCT/IB04/51899

§ 371 Date: Mar. 29, 2006

Related U.S. Application Data
(60) Provisional application No. 60/507,093, filed on Sep. 30, 2003.

(51) Int. Cl. G06K 9/00

(52) U.S. Cl. 382/115

(57) ABSTRACT

A system and method is provided for adaptively setting biometric measurement thresholds in a biometric measurement system. A biometric measurement system comprises a biometric sensor, an analysis unit, and an output unit. The invention comprises an environmental sensor that measures a value of an environmental parameter of the ambient environment of the biometric measurement system. The invention also comprises an adaptive threshold setting unit that adaptively sets an adjustable biometric measurement threshold in the analysis unit using a value of the environmental parameter measured by the environmental sensor. The analysis unit analyzes biometric measurements received from the biometric sensor and uses the adjusted biometric measurement threshold to take into account the influence of environmental changes.

The present invention is directed, in general, to biometric measurement systems and, more specifically, to a system and method for adaptively setting biometric measurement thresholds in a biometric measurement system.

A prior art biometric measurement system typically comprises a biometric sensor, an analysis unit, and an output unit. The biometric sensor takes a biometric measurement and provides the biometric measurement to the analysis unit. The analysis unit analyzes the biometric measurement to make a determination whether the biometric measurement meets a predetermined requirement. The result of the analysis is provided to the output unit of the biometric measurement system.

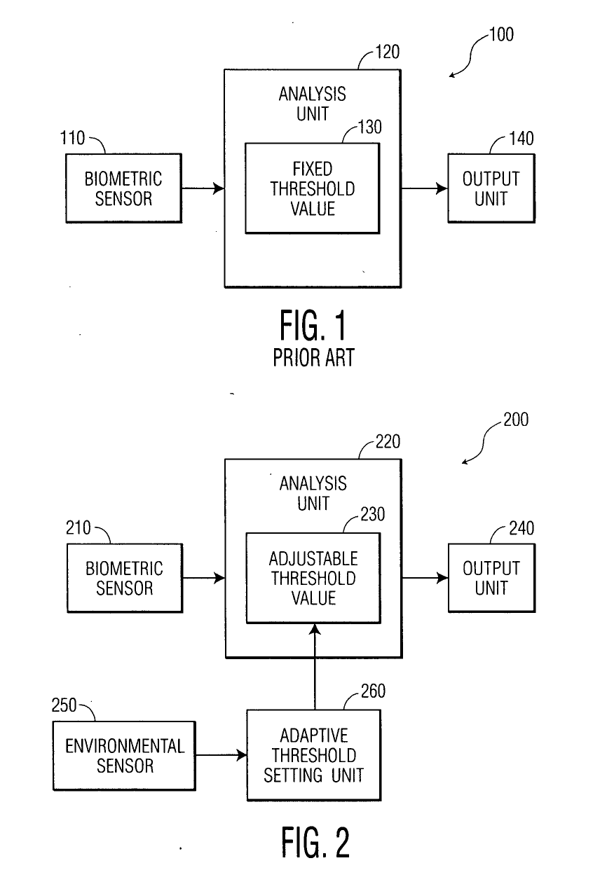

An exemplary prior art biometric measurement system 100 is shown in FIG. 1. Biometric sensor 110 takes a measurement of a biometric characteristic. Biometric characteristics may include, but are not limited to, voice characteristics, images of facial features, fingerprints, retinal patterns, signatures, and the like. Biometric sensor 110 provides the biometric measurement to analysis unit 120. If analysis unit 120 is a voice identification analysis unit, for example, then biometric sensor 110 is a microphone that records a speaker's voice. Analysis unit 120 typically comprises a fixed threshold value 130 that represents a value of an applicable environmental parameter.

In the example set forth above in which the analysis unit 120 is a voice identification analysis unit, the applicable environmental parameter may comprise a signal to noise ratio. If the biometric measurement of the speaker's voice that is obtained from biometric sensor 110 (i.e., the microphone) is such that the signal to noise level of the speaker's voice is less than the fixed signal to noise ratio 130, then the analysis unit 120 will disregard the biometric measurement of the speaker's voice. If the biometric measurement of the speaker's voice that is obtained from biometric sensor 110 (i.e., the microphone) is such that the signal to noise level of the speaker's voice is equal to or greater than the fixed signal to noise ratio 130, then the analysis unit 120 will analyze the biometric measurement of the speaker's voice. The analysis unit 120 then outputs the result of the analysis to output unit 140.

It is well known that the performance of a biometric measurement system depends upon the environment in which the biometric measurement system operates. For example, in the presence of lighting conditions that are nearly ideal, a prior art face recognition analysis system might give scores in a higher range. On the other hand, the same prior art face recognition analysis system might give scores in a lower range in the presence of poor lighting conditions. The prior art face recognition system compares the biometric measurements of facial images using a fixed value threshold for ambient illumination. Therefore the prior art face recognition system is likely to classify a facial image obtained in the presence of poor lighting conditions as “not matching” a target facial image. This results in a “false negative” determination because the facial image would have matched the target facial image in the presence of good lighting conditions. The prior art face recognition system cannot detect changes in the illumination level of the ambient environment.

There is therefore a need in the art for a system and method that is capable of adaptively setting a biometric measurement threshold in a biometric measurement system in order to take into account changes that occur in the ambient environment in which a biometric measurement is made.

To overcome the inadequacies of the prior art, the system and method of the present invention is capable of adaptively setting a biometric measurement threshold in a biometric measurement system. The system and method of the present invention comprises an environmental sensor that is able to measure changes in an environmental parameter of the ambient environment of the biometric measurement system.

The environmental sensor makes an environmental measurement and sends the environmental measurement to an adaptive threshold setting unit. The adaptive threshold setting unit uses the environmental measurement to set an environmental threshold value and sends the environmental threshold value to the analysis unit of the biometric measurement system. The analysis unit changes the value of a corresponding adjustable threshold value to conform it to the environmental threshold value from the adaptive threshold setting unit. The analysis unit then performs an analysis of biometric measurements using the adjusted threshold value that takes the environmental change into account.

The present invention may be utilized in many different types of applications. For example, in one advantageous embodiment of the present invention the biometric measurement system comprises a voice identification system and the environmental parameter measured by the environmental sensor is a signal to noise ratio. In another advantageous embodiment of the present invention the biometric measurement system comprises a face recognition system and the environmental parameter measured by the environmental sensor is a measure of the intensity of the ambient light. In yet another advantageous embodiment of the present invention the biometric measurement system comprises a fingerprint identification system and the environmental parameter measured by the environmental sensor is a measure of the humidity of the ambient air.

It is an object of the present invention to provide a system and method for adaptively setting an adjustable biometric measurement threshold in a biometric measurement system.

It is another object of the present invention to provide a system and method for adaptively setting an adjustable biometric measurement threshold in a biometric measurement system using at least one value of an environmental parameter of the ambient environment of the biometric measurement system.

It is also an object of the present invention to provide an apparatus for adaptively setting an adjustable biometric measurement threshold in a biometric measurement system that comprises an environmental sensor and an adaptive threshold setting unit.

It is another object of the present invention to provide a voice identification system that is capable of setting an adjustable signal to noise ratio threshold using a measurement of the ambient signal to noise ratio of the voice identification system.

It is yet another object of the present invention to provide a face recognition system that is capable of setting an adjustable light intensity threshold using a measurement of the ambient light intensity of the face recognition system.

It is still another object of the present invention to provide a fingerprint identification system that is capable of setting an adjustable air humidity threshold using a measurement of the ambient air humidity of the fingerprint identification system.

It is also an object of the present invention to provide an apparatus for adaptively setting an adjustable biometric measurement threshold in a biometric measurement system that comprises a plurality of environmental sensors and an adaptive thresholds setting unit that is capable of setting a plurality of adjustable biometric measurement thresholds in a biometric measurement system.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art should appreciate that they may readily use the conception and the specific embodiment disclosed as a basis for modifying or designing other structures for carrying out the same purposes of the present invention. Those skilled in the art should also realize that such equivalent constructions do not depart from the spirit and scope of the invention in its broadest form.

Before undertaking the Detailed Description of the Invention, it may be advantageous to set forth definitions of certain words and phrases used throughout this patent document: the terms “include” and “comprise” and derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term 2 0 “controller,” “processor,” or “apparatus” means any device, system or part thereof that controls at least one operation, such a device may be implemented in hardware, firmware or software, or some combination of at least two of the same. It should be noted that the functionality associated with any particular controller may be centralized or distributed, whether locally or remotely. In particular, a controller may comprise one or more data processors, and associated input/output devices and memory, that execute one or more application programs and/or an operating system program. Definitions for certain words and phrases are provided throughout this patent document. Those of ordinary skill in the art should understand that in many, if not most instances, such definitions apply to prior uses, as well as future uses, of such defined words and phrases.

For a more complete understanding of the present invention, and the advantages thereof, reference is now made to the following descriptions taken in conjunction with the accompanying drawings, wherein like numbers designate like objects, and in which:

FIG. 1 is a block diagram that illustrates a prior art biometric measurement system;

FIG. 2 is a block diagram that illustrates an advantageous embodiment of a biometric measurement system with an environmental sensor and an adaptive threshold setting unit for adaptively determining an environmental threshold in accordance with the principles of the present invention;

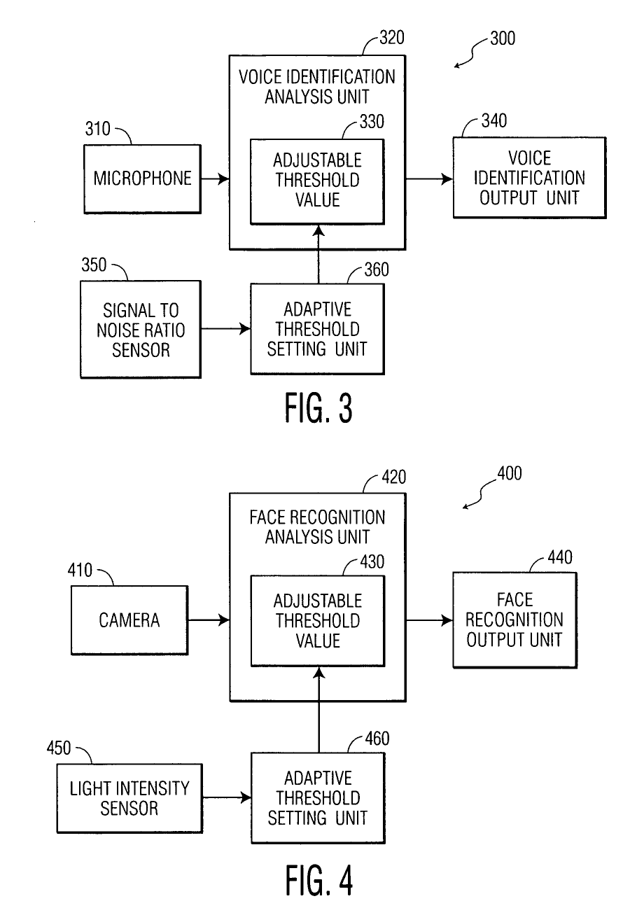

FIG. 3 is a block diagram that illustrates an advantageous embodiment of a voice identification system with a signal to noise ratio sensor and an adaptive threshold setting unit for adaptively determining a noise threshold in accordance with the principles of the present invention;

FIG. 4 is a block diagram that illustrates an advantageous embodiment of a face recognition system with a light intensity sensor and an adaptive threshold setting unit for adaptively determining a light threshold in accordance with the principles of the present invention;

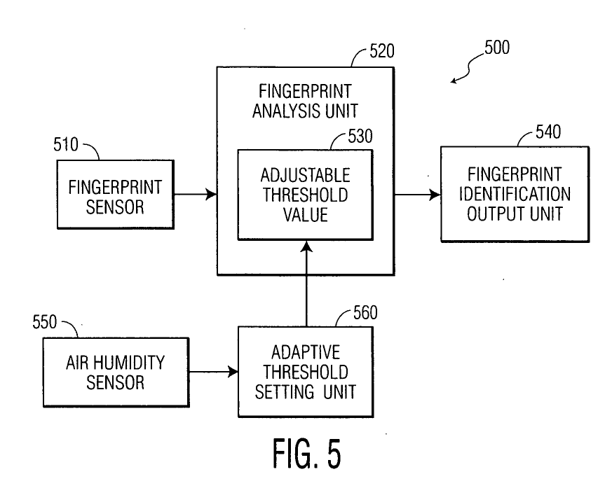

FIG. 5 is a block diagram that illustrates an advantageous embodiment of a fingerprint recognition system with an air humidity sensor and an adaptive threshold setting unit for adaptively determining an air humidity threshold in accordance with the principles of the present invention;

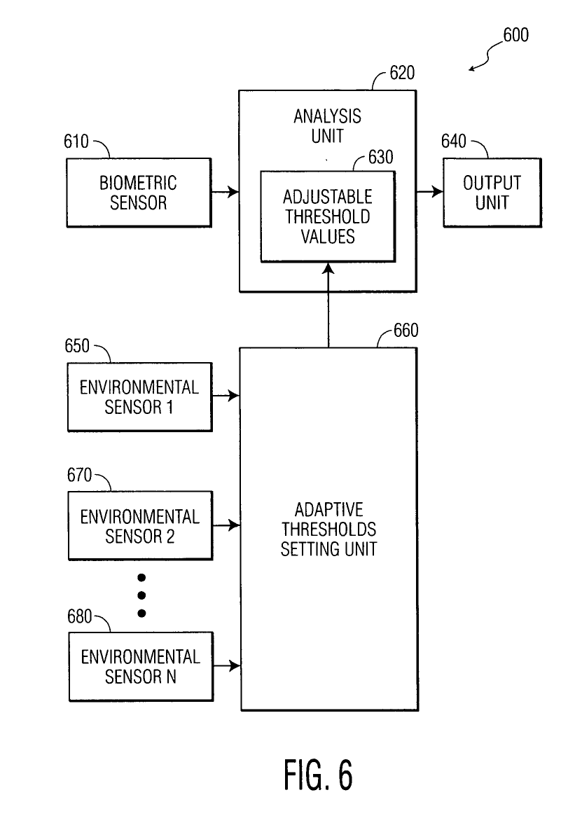

FIG. 6 is a block diagram that illustrates an advantageous embodiment of a biometric measurement system with a plurality of environmental sensors and an adaptive thresholds setting unit for adaptively determining a plurality of environmental thresholds in accordance with the principles of the present invention; and

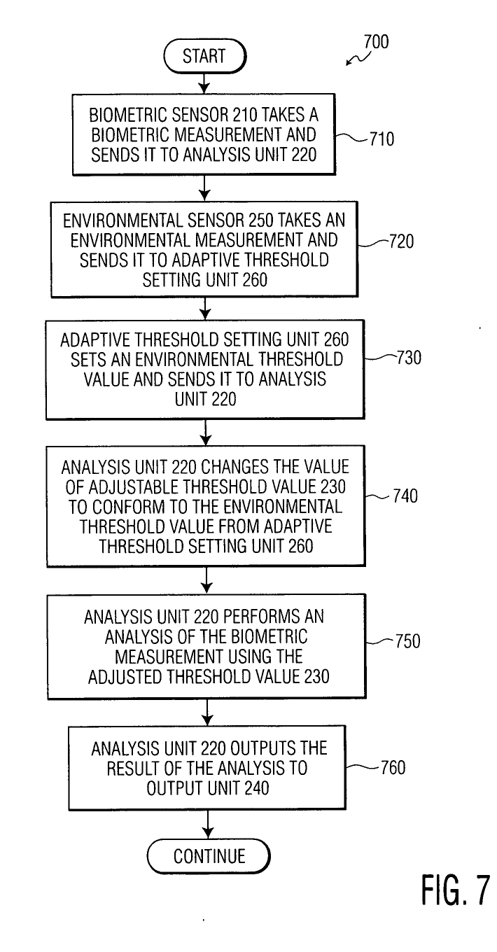

FIG. 7 illustrates a flowchart showing the steps of an advantageous embodiment of the method of the invention.

FIGS. 2 through 7, discussed below, and the various embodiments used to describe the principles of the present invention in this patent document are by way of illustration only and should not be construed in any way to limit the scope of the invention. The present invention may be used in any suitable biometric measurement system.

FIG. 2 is a block diagram that illustrates an advantageous embodiment of a biometric measurement system 200 that comprises an environmental sensor 250 and an adaptive threshold setting unit 260 for adaptively adjusting a threshold value of an environmental parameter in accordance with the principles of the present invention. Biometric measurement system 200 also comprises biometric sensor 210, analysis unit 220, and output unit 240. Analysis unit 220 comprises an adjustable threshold value 230 of the environmental parameter.

Biometric sensor 210 takes a biometric measurement and provides the biometric measurement to the analysis unit 220. The analysis unit 220 then analyzes the biometric measurement to make a determination whether the biometric measurement meets a predetermined requirement. As will be more fully described, analysis unit 220 uses a value of the environmental parameter that has been adjusted by adaptive threshold setting unit 260. Analysis unit provides the result of the analysis to the output unit 240.

Environmental sensor 250 measures the ambient environment of biometric measurement system 200 and makes a determination of the value of the environmental parameter. Environmental sensor 250 provides the measured value of the environmental parameter to adaptive threshold setting unit 260. In response to receiving the measured * value of the environmental parameter, adaptive threshold setting unit 260 modifies the threshold value of the environmental parameter (if necessary) and sends the new threshold value of the environmental parameter to analysis unit 220.

Analysis unit 220 changes the value of adjustable threshold value 230 to conform to the new threshold value of the environmental parameter received from adaptive threshold setting unit 260. Analysis unit 220 then performs the analysis of the biometric measurement from biometric sensor 210 using the adjusted threshold value 230. Analysis unit 220 then outputs the result of the analysis to output unit 240.

As biometric measurement system 200 continues to operate, environmental sensor 250 continually takes readings of the ambient environment. Environmental sensor 250 continually provides updated readings of the environmental parameter to adaptive threshold setting unit 260. Adaptive threshold setting unit 260 continually provides updated threshold values for the environmental parameter. In this manner, biometric measurement system 200 is able to continually adapt to changes in the environment.

Biometric measurement system 200 of the present invention may be utilized in many different types of applications. For example, FIG. 3 illustrates an advantageous embodiment of the present invention that comprises a voice identification system 300. The biometric sensor 310 comprises a microphone. The analysis system comprises a voice identification analysis unit 320. The output unit comprises a voice identification output unit 340. The environmental sensor 350 comprises a signal to noise ratio sensor.

Microphone 310 detects a speaker's voice and provides a signal that represents the speaker's voice to voice identification analysis unit 320. Voice identification analysis unit 320 then analyzes the speaker's voice to determine whether the speaker's voice matches a prerecorded target voice pattern. Voice identification analysis unit 320 provides the result of the analysis to voice identification output unit 340.

Signal to noise ratio sensor 350 measures the ambient environment of voice identification system 300 and determines the value of the signal to noise ratio in the environment. Signal to noise ratio sensor 350 provides the measured value of the signal to noise ratio to adaptive threshold setting unit 360. In response to receiving the measured value of the signal to noise ratio, adaptive threshold setting unit 360 modifies the threshold value of the signal to noise ratio (if necessary) and sends the new threshold value of the signal to noise ratio to voice identification analysis unit 320.

Voice identification analysis unit 320 changes the value of the adjustable threshold value 330 of the signal to noise ratio to conform to the new threshold value of the signal to noise ratio received from adaptive threshold setting unit 360. Voice identification analysis unit 320 then analyzes the speaker's voice received from microphone 310 using the adjusted threshold value 330 of the signal to noise ratio. Voice identification analysis unit 320 then outputs the result of the analysis to voice identification output unit 340.

FIG. 4 illustrates an advantageous embodiment of the present invention that comprises a face recognition system 400. The biometric sensor 410 comprises a camera. The analysis system comprises a face recognition analysis unit 420. The output unit comprises a face recognition output unit 440. The environmental sensor 450 comprises a light intensity sensor.

Camera 410 takes a picture of a person's face and provides a signal that represents the person's face to face recognition analysis unit 420. Face recognition analysis unit 420 then analyzes the person's face to determine whether the person's face matches a prerecorded target facial pattern. Face recognition analysis unit 420 provides the result of the analysis to face recognition output unit 440.

Light intensity sensor 450 measures the ambient environment of face recognition system 400 and determines the value of the light intensity in the environment. Light intensity sensor 450 provides the measured value of the light intensity to adaptive threshold setting unit 460. In response to receiving the measured value of the light intensity, adaptive threshold setting unit 460 modifies the threshold value of the light intensity (if necessary) and sends the new threshold value of the light intensity to face recognition analysis unit 420.

Face recognition analysis unit 420 changes the value of the adjustable threshold value 430 of the light intensity to conform to the new threshold value of the light intensity received from adaptive threshold setting unit 460. Face recognition analysis unit 420 then analyzes the person's face received from camera 410 using the adjusted threshold value 430 of the light intensity. Face recognition analysis unit 420 then outputs the result of the analysis to face recognition output unit 440.

FIG. 5 illustrates an advantageous embodiment of the present invention that comprises a fingerprint identification system 500. The biometric sensor 510 comprises a fingerprint sensor. The analysis system comprises a fingerprint analysis unit 520. The output unit comprises a fingerprint identification output unit 540. The environmental sensor 550 comprises an air humidity sensor.

Fingerprint sensor 510 takes an impression of a person's fingerprint and provides a signal that represents the person's fingerprint to fingerprint analysis unit 520. Fingerprint analysis unit 520 then analyzes the person's fingerprint to determine whether the person's fingerprint matches prerecorded target fingerprint patterns. Fingerprint analysis unit 520 provides the result of the analysis to fingerprint identification output unit 540.

Air humidity sensor 550 measures the ambient environment of fingerprint identification system 500 and determines the value of the humidity of the air in the environment. Air humidity sensor 550 provides the measured value of the air humidity to adaptive threshold setting unit 560. In response to receiving the measured value of the air humidity, adaptive threshold setting unit 560 modifies the threshold value of the air humidity (if necessary) and sends the new threshold value of the air humidity to fingerprint analysis unit 520.

Fingerprint analysis unit 520 changes the value of the adjustable threshold value 530 of the air humidity to conform to the new threshold value of the air humidity received from adaptive threshold setting unit 560. Fingerprint analysis unit 520 then analyzes the person's fingerprint received from fingerprint sensor 510 using the adjusted threshold value 530 of the air humidity. Fingerprint analysis unit 520 then outputs the result of the analysis to fingerprint identification output unit 540.

FIG. 6 illustrates an advantageous embodiment of the present invention that comprises a biometric measurement system 600. Biometric measurement system 600 comprises a plurality of environmental sensors. Biometric measurement system 600 illustrates that the system and method of the present invention may comprise more than one environmental sensor. The environmental sensors may be operated individually or, alternatively, may be operated simultaneously.

Biometric measurement system 600 comprises biometric sensor 610, analysis unit 620, a plurality of adjustable threshold values 630, and output unit 640. Biometric measurement system 600 also comprises a plurality of N environmental sensors 650,670, 680 where the letter N designates an integer value. Biometric measurement system 600 also comprises an adaptive thresholds setting unit 660 that is capable of adaptively setting thresholds for each of the plurality of environmental sensors 650, 670, 680 in response to receiving values of environmental parameters from the plurality of environmental sensors 650, 670, 680. The operation of biometric measurement system 600 is similar to the operation of the previously described embodiments of the invention, except that a plurality of threshold values may be utilized by analysis unit 620.

FIG. 7 illustrates a flowchart showing the steps of an advantageous embodiment of the method of the invention. The steps of the method shown in FIG. 7 are collectively referred to with reference numeral 700. In the first step, biometric sensor 210 takes a biometric measurement and sends the biometric measurement to analysis unit 220 (step 710). Then environmental sensor 250 takes an environmental measurement and sends the environmental measurement to adaptive threshold setting unit 260 (step 720). Adaptive threshold setting unit 260 sets an environmental threshold value and sends the environmental threshold value to analysis unit 220 (step 730).

Analysis unit 220 then changes the value of adjustable threshold value 230 to conform to the environmental threshold value from adaptive threshold setting unit 260 (step 740). Analysis unit 220 performs an analysis of the biometric measurement using the adjusted threshold value 230 (step 750). Analysis unit 220 then outputs the result of the analysis to output unit 240 (step 760).

While the present invention has been described in detail with respect to certain embodiments thereof, those skilled in the art should understand that they can make various changes, substitutions modifications, alterations, and adaptations in the present invention without departing from the concept and scope of the invention in its broadest form.

1. An apparatus (250,260) in a biometric measurement system (200) that adaptively sets at least one adjustable biometric measurement threshold (230) in said biometric measurement system (200).

2. An apparatus (250,260) as claimed in claim 1 wherein said apparatus (250,260) adaptively sets said at least one adjustable biometric measurement threshold (230) in said biometric measurement system (200) using at least one value of an environmental parameter of an ambient environment of said biometric measurement system (200).

3. An apparatus (250,260) as claimed in claim 2 wherein said apparatus (250,260) comprises:
an environmental sensor (250) that measures said at least one value of said environmental parameter of said ambient environment of said biometric measurement system (200); and
an adaptive threshold setting unit (260) that adaptively sets said at least one adjustable biometric measurement threshold using said at least one value of said environmental parameter measured by said environmental sensor (250).

4. An apparatus (250,260) as claimed in claim 3 wherein said biometric measurement system (200) comprises a biometric sensor (210) and an analysis unit (220), and wherein said analysis unit (220) analyzes biometric measurements from said biometric sensor (210) using at least one adjustable biometric measurement threshold adaptively set by said adaptive threshold setting unit (260).

5. An apparatus (350,360) as claimed in claim 4 wherein said biometric measurement system (300) comprises a voice identification system (300) and said environmental parameter measured by said environmental sensor (350) comprises a signal to noise ratio.

6. An apparatus (450,460) as claimed in claim 4 wherein said biometric measurement system (400) comprises a face recognition system (400) and said environmental parameter measured by said environmental sensor (450) comprises light intensity.

7. An apparatus (550,560) as claimed in claim 4 wherein said biometric measurement system (500) comprises a fingerprint identification system (500) and said environmental parameter measured by said environmental sensor (550) comprises air humidity.

8. An apparatus (650,660,670,680) as claimed in claim 2 wherein said apparatus (650,660,670,680) comprises:
a plurality of environmental sensors (650,670,680) in which each environmental sensor (650,670,680) measures a value of an environmental parameter of said ambient environment of said biometric measurement system (600); and
an adaptive thresholds setting unit (660) that adaptively sets each of a plurality of adjustable biometric measurement thresholds (630) using a respective environmental parameter of said plurality of environmental parameters measured by said plurality of environmental sensors (650,670,680).

9. A method for use in analyzing biometric measurements in a biometric measurement system, said method comprising the step of adaptively setting at least one adjustable biometric measurement threshold in said biometric measurement system.

10. The method as claimed in claim 9 further comprising the step of:
using at least one value of an environmental parameter of an ambient environment of said biometric measurement system to set said at least one adjustable biometric measurement threshold in said biometric measurement system.

11. The method as claimed in claim 10 further comprising the steps of:
measuring with an environmental sensor said at least one value of said environmental parameter of said ambient environment of said biometric measurement system; and
adaptively setting with an adaptive threshold setting unit said at least one adjustable biometric measurement threshold using said at least one value of said environmental parameter measured by said environmental sensor.

12. The method as claimed in claim 11 wherein said biometric measurement system comprises a biometric sensor and an analysis unit, and wherein said method further comprises the step of:
analyzing in said analysis unit biometric measurements from said biometric sensor using at least one adjustable biometric measurement threshold adaptively set by said adaptive threshold setting unit.

13. The method as claimed in claim 12 wherein said biometric measurement system comprises a voice identification system and said environmental parameter measured by said environmental sensor comprises a signal to noise ratio.

14. The method as claimed in claim 12 wherein said biometric measurement system comprises a face recognition system and said environmental parameter measured by said environmental sensor comprises light intensity.

15. The method as claimed in claim 12 wherein said biometric measurement system comprises (500) a fingerprint identification system (500) and said environmental parameter measured by said environmental sensor (550) comprises air humidity.

16. The method as claimed in claim 10 further comprising the steps of:
measuring with each environmental sensor of a plurality of environmental sensors a value of an environmental parameter of said ambient environment of said biometric measurement system; and
adaptively setting with an adaptive thresholds setting unit each of a plurality of adjustable biometric measurement thresholds using a respective environmental parameter measured by each environmental sensor of said plurality of environmental sensors.

17. A signal generated by a method for use in analyzing biometric measurements in a biometric measurement system (200), said method comprising the step of adaptively setting at least one adjustable biometric measurement threshold (230) in said biometric measurement system (200).

18. A signal as claimed in claim 17 wherein said method further comprises the step of:
using at least one value of an environmental parameter of an ambient environment of said biometric measurement system (200) to set said at least one adjustable biometric measurement threshold (230) in said biometric measurement system (200).

19. A signal as claimed in claim 18 wherein said method further comprises the steps of:
measuring with an environmental sensor said at least one value of said environmental parameter of said ambient environment of said biometric measurement system; and
adaptively setting with an adaptive threshold setting unit said at least one adjustable biometric measurement threshold using said at least one value of said environmental parameter measured by said environmental sensor.

20. A signal as claimed in claim 19 wherein said biometric measurement system comprises a biometric sensor and an analysis unit, and wherein said method further comprises the step of:
analyzing in said analysis unit biometric measurements from said biometric sensor using at least one adjustable biometric measurement threshold adaptively set by said adaptive threshold setting unit.

21. A signal as claimed in claim 20 wherein said biometric measurement system comprises a voice identification system and said environmental parameter measured by said environmental sensor comprises a signal to noise ratio.

22. A signal as claimed in claim 20 wherein said biometric measurement system comprises a face recognition system and said environmental parameter measured by said environmental sensor comprises light intensity.

23. A signal as claimed in claim 20 wherein said biometric measurement system comprises a fingerprint identification system and said environmental parameter measured by said environmental sensor comprises air humidity.

24. A signal as claimed in claim 18 wherein said method further comprises the steps of:
measuring with each environmental sensor of a plurality of environmental sensors a value of an environmental parameter of said ambient environment of said biometric measurement system; and
adaptively setting with an adaptive thresholds setting unit each of a plurality of adjustable biometric measurement thresholds using a respective environmental parameter measured by each environmental sensor of said plurality of environmental sensors.
